(19) United States
(12) Patent Application Publication
(10) Pub. No.: US 2016/0306937 A1
(43) Pub. Date: Oct. 20, 2016

(54) SMART HEALTH MANAGEMENT SERVICE AND SYSTEM BY USING AUTOMATION PLATFORM INSTALLED IN SMART PHONES

(71) Applicant: My 911, La Mirada, CA (US)

(72) Inventor: Yun Hwi LEE, Seongnam (KR)

(21) Appl. No.: 15/098,953

(22) Filed: Apr. 14, 2016

Related U.S. Application Data
(60) Provisional application No. 62/147,769, filed on Apr. 15, 2015.

(51) Int. Cl. G06F 19/00

(52) U.S. Cl. CPC G06F 19/345; G06F 19/3443

(57) ABSTRACT

The invention relates to the method and system for smart health management service by using an automation platform installed in smart phones in order to provide smart phone users with tailored and self-supporting service system. In order to acquire goods and services, which provide solutions to problems, either on a regular or irregular basis, self-maintenance and control, healthy life management, financial management, self-management and planning, the program causes the Server automatically to perform the method and system that comprises transmitting the personal characteristics information related to wellness and health with ease measurement and assessment, and quality control.

### CROSS-REFERENCE TO RELATED APPLICATIONS

This application claims the benefit of U.S. Provisional Application No. 62/147,769 filed on Apr. 15, 2015. The entire disclosure of the above application is incorporated herein by reference.

### FIELD

The present invention relates to the method and system for smart health management services by using automation platform installed in smart phones in order to provide smart phone users with tailored supporting service system.

### BACKGROUND

Due to recent changes in the medical technology, the International Classification of Diseases (ICD) is designed as a health care classification system, to promote international comparability in the collection, processing, classification, and presentation of mortality statistics; and to provide a system of diagnostic codes for classifying diseases, including nuanced classifications of a wide variety of signs, symptoms, abnormal findings, complaints, social circumstances, and external causes of injury or disease. This system is designed to map health conditions to corresponding generic categories together with specific variations, assigning for these a designated code, up to six characters long. Thus, major categories are designed to include a set of similar diseases.

The ICD is the standard diagnostic tool as WHO's framework for epidemiology, health management and clinical purposes. This includes the analysis of the general health situation of population groups. It is used to monitor the incidence and prevalence of diseases and other health-related problems, proving a picture of the general health situation of countries and populations.

The ICD is the global standard to report and categorize diseases in order to compile health information related to deaths, illness and injury, and a multi-purpose classification intended for a wide range of uses in different sectors. WHO aims to produce the ICD with all necessary digital tools to enable others to use it in their systems as an international standard.

As a range of capabilities of the ICF is also included in the ICD concept, the ICF qualifiers can describe and quantify the encoding extent of the overlapping scale and character by using independent objects (definition, implied), signs and symptoms, severity and the diagnostic criteria.

The ICF is a classification of health and health-related domains—domains that help us to describe changes in body function and structure, what a person with a health condition can do in a standard environment (their level of capacity), as well as what they actually do in their usual environment (their level of performance). These domains are classified from body, individual and social perspectives by means of two lists: (1) a list of body functions and structure, and (2) a list of domains of activity and participation. In the ICF, the term functioning refers to all body functions, activities and participation, while disability is similarly an umbrella term for impairments, activity limitations and participation restrictions. The ICF also lists environmental factors that interact with all these components.

The ICF is the conceptual basis for (1) the definition, mapping and measurement formulations for health, disability and complete physical, mental, social well-being; (2) the description of the functioning level of daily life and work in a more time efficient way; (3) an optimal functioning tool to resolve problems independently by selecting the expert who can be accompanied with the optimum level of purpose in a person's life (development, participation and environment); and (4) a tool of personal budget system to provide reasonable budgeting and sharing suitable for personal needs. The ICF therefore looks like a simple health classification, but it can be used for a number of purposes. The most important is as a planning tool for a tailored decision-making.

As all aspects of a person's life are thus incorporated into the ICF, (1) the ICF can serve as a practical tool (a) to provide an action-based model behavior and the golden schedule on the ground of activity-based personal life and regular activity model; and (b) to provide goal management by using coaching system in order to achieve a reasonable personal goal; and (2) the ICF can play important roles in (a) understanding the problem and the level of problem solving sequence with the field of a person's life in the background; and (b) enabling the role as a tool evolved for customers to take advantage of designing the occupation goal and resolving the problem by using available resources in person.

The current ICF creates a more integrative understanding of health forming a comprehensive profile of an individual instead of focusing on one's health condition. The implications of using the ICF include emphasizing on the strengths of individuals, assisting individuals in participating more extensively in society by the use of interventions aimed at enhancing their abilities, and taking into consideration the environmental and personal factors that might hamper one's participation. As the ICF qualifiers are best translated clinically as the levels of functioning seen in a standardized or clinic setting and in everyday environments, qualifiers support standardization and the understanding of functioning in a multidisciplinary assessment and enable all team members to quantify the extent of problems, even in areas of functioning with scores from 0 to 100 (Smart Index).

The ICF is the conceptual basis for an optimal functioning tool to resolve problems independently by selecting the expert who can be accompanied with the optimum level of purpose in a person's life and a tool of personal budget system to provide reasonable budgeting and sharing suitable for personal needs.

The ICD/ICF as an international common standard language designing a reasonable individual life enables better planning of services, temporary/auxiliary/supporting treatment, recovery, and rehabilitation for persons with long-term health-related problems, diseases, disabilities or chronic conditions.

There is a need for an improved system for health management service and system which relates to the method and system by using automation platform installed in smart phones in order to provide smart phone users with tailored and self-supporting service system. In order to acquire goods and services, which provide solutions to diseases and health-related problems, either on a regular or irregular basis, self-maintenance and control, healthy life management, financial management, self-management and planning, the program causes automatically the Server to perform the method and system that comprises transmitting the personal data related to wellness and health with ease measurement and assessment, and quality control.

This invention enables smart phone users to measure and assess wellness and health for individuals and current or future health supporting products and services (items by way of ICD and ICF) by using multi-analysis algorithms.

### SUMMARY

This invention enables smart phone users (1) to measure and assess wellness and health for individuals and current or future life supporting products and services (items by way of ICD and ICF) by using multi-analysis algorithms; (2) to provide consulting and supporting tools of experts and business people with regard to wellness and health supporting products and services, the need for an extension period, business management including R&D, manufacturing and marketing, maintenance of a balance between clothing, food and housing through ones' entire life, healthcare, financial affairs, the need for financial assistance and support, financial management, social activities and participation, environmental factors; (3) to input and store individual data of smart phone users e.g., gender, age, smoking habit, consumption patterns, information of social activities, measuring methods and levels of the specific functions and activities of body parts, degree of difficulties, satisfaction level of life, which are classified according to category response, in order to measure directly the objective number/value (score—Smart Index) in relation to the items requested or selected by smart phone users, by using multi-analysis algorithms installed in smart phones; and (4) to calculate and measure individual scores of wellness and health arranging from 0 to 100 (comparing the quality level of an individual life as a barometer in smart phones—Smart Index).

The invention relates to the method and system for smart health management by using automation platform installed in smart phones in order to provide smart phone users with tailored and self-supporting service system. In order to acquire goods and services, which provide solutions to health-related problems, either on a regular or irregular basis, self-maintenance and control, healthy life management, financial management, self-management and planning, the program causes automatically the Server to perform the method and system that comprises transmitting the personal data related to wellness and health with ease measurement and assessment, and quality control.

### BRIEF DESCRIPTION OF DRAWINGS

The accompanying drawings, which are incorporated in and constitute a part of the specification, illustrate embodiment of the invention, and together with the general description given above and the detailed description of the embodiment given below, serve to explain the principles of the invention.

FIG. 1 is a flowchart showing flow of process of operating system by using the mobile terminal in the present invention;

FIG. 2 is a diagram showing a general configuration of operating system of the present invention;

FIG. 3 is a diagram showing integral components of the main server in a second embodiment of the present invention.

FIG. 4a is a diagram showing integral components of membership data processing of the present invention;

FIG. 4b is a flowchart showing flow of process of joining a membership of the present invention;

FIG. 5 is a diagram showing the parties to the present invention;

FIG. 6 is a flowchart showing flow of scalable computation engine and progress of analyzing healthcare platform in a first embodiment of the present invention;

FIG. 7 is a flowchart showing flow of program structure of healthcare analytic platform in a sixth embodiment of the present invention;

FIG. 8 is a flowchart showing flow of progress of receiving a final report by the classification system in a sixth embodiment of the present invention;

FIG. 9a, FIG. 9b, FIG. 9c and FIG. 9d are flowcharts showing flow of progress of storing the member's information/data in Report DB (18) by using question items and response, algorithms and latent variables, the ICD/ICF as an international common standard language through Question Item DB (14), Response DB (15), Algorithm DB (16) and Index DB (17);

FIG. 10 is a flowchart showing flow of progress of selecting trading items, executing trading transactions, verifying members, approving transactions and transmitting trading records in a first embodiment of the present invention;

FIG. 11 is a flowchart showing flow of process of settlement transactions in a sixth embodiment of the present invention;

FIG. 12 is a flowchart showing flow of process of applying a loan application in a sixth embodiment of the present invention;

FIG. 13a, FIG. 13b, FIG. 13c and FIG. 13d are diagrams showing an example of the menu screen displayed in the receiving mobile terminal in ninth embodiments of the present invention;

FIG. 14a, FIG. 14b and FIG. 14c are diagrams showing an example of Question Items and Response displayed in the receiving mobile terminal in ninth embodiments of the present invention; and

FIG. 15a and FIG. 15b are graphs/diagrams showing an example of the scoring and the trading list displayed in the receiving mobile terminal in tenth embodiment of the present invention.

### DESCRIPTION OF EMBODIMENTS

Referring now to the drawings, preferred embodiments of the invention are described in detail below. However, the technical scope of the present invention is not restricted to these embodiments.

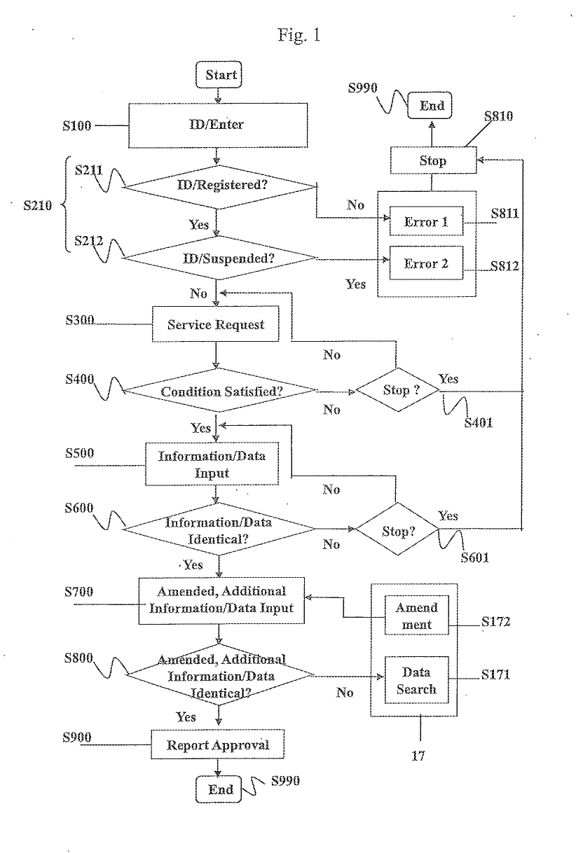

FIG. 1 is a flowchart showing flow of process of operating system by using the mobile terminal in the present invention.

Referring to FIG. 1, block 100 represents the user who connects the site and waits to confirm Member ID via the mobile terminal. Once Member ID is confirmed, control is transferred to blocks 210-990 to identify the request and respond accordingly.

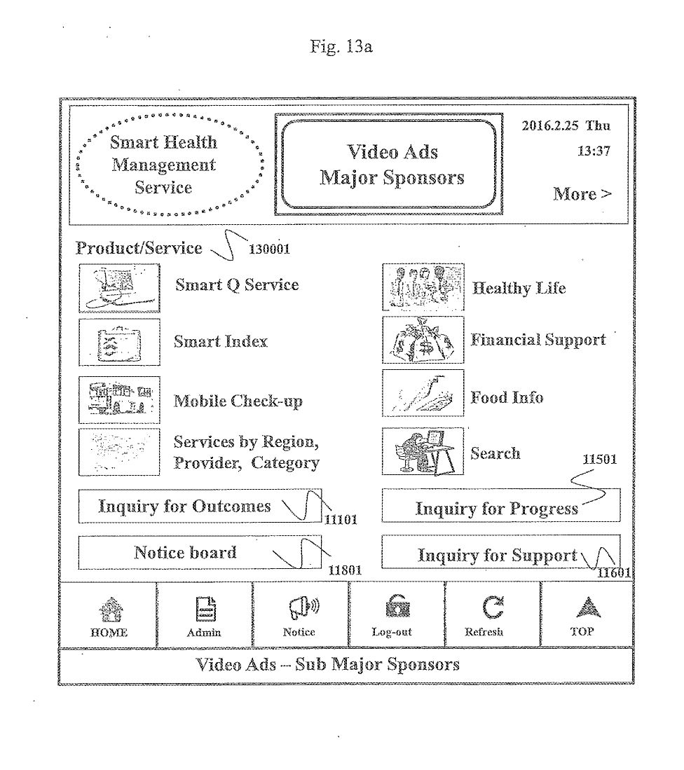

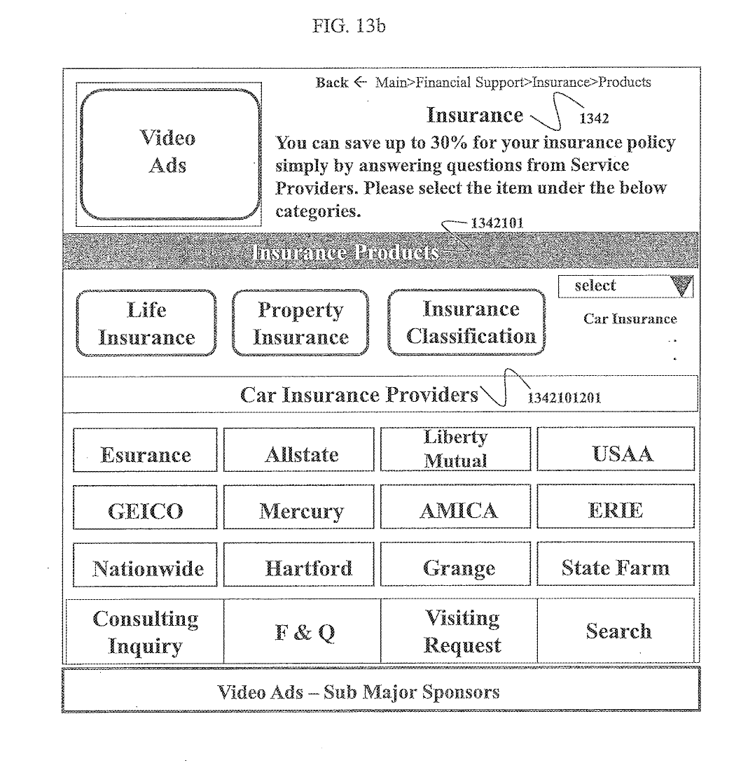

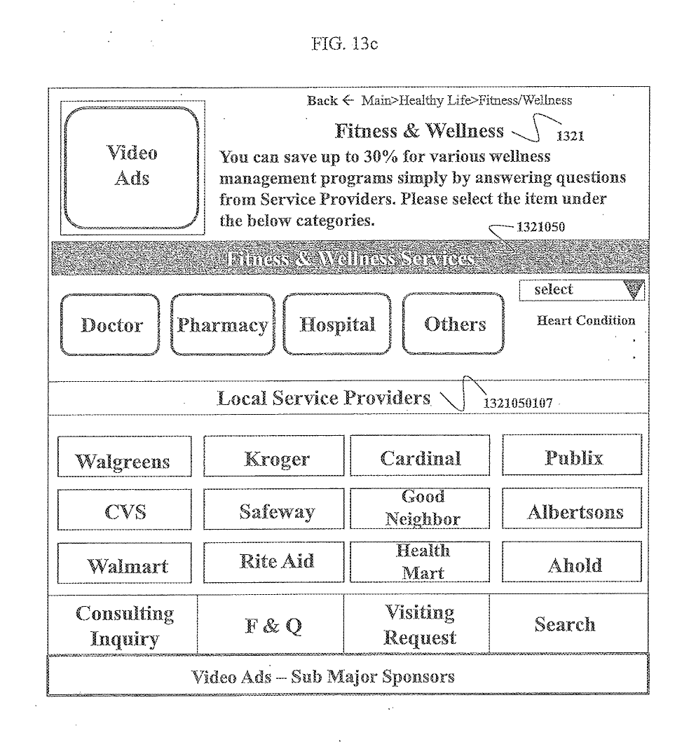

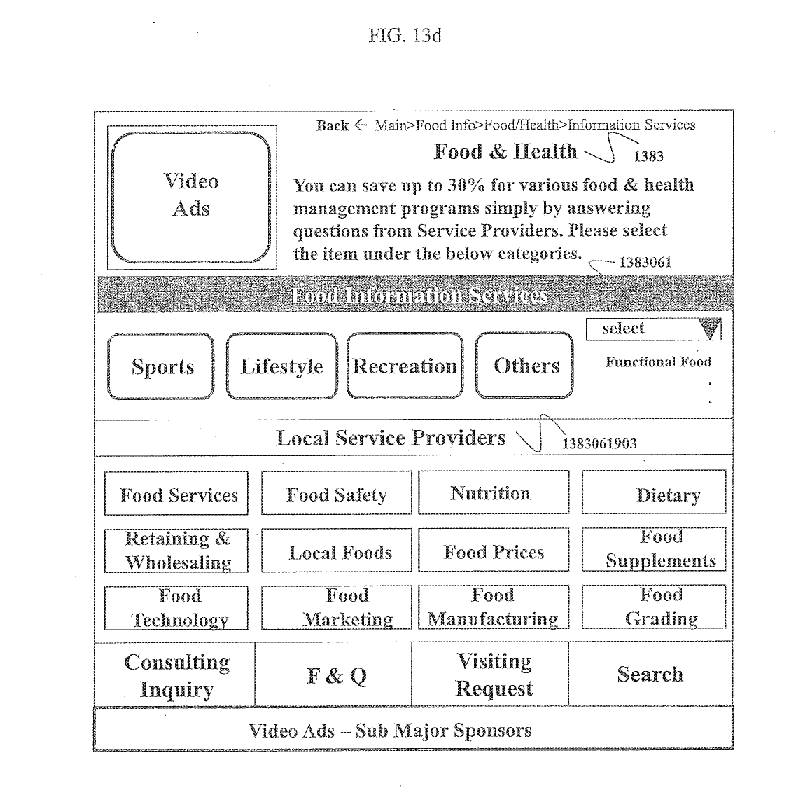

Blocks 211-212 are decision blocks determining whether the user is allowed to process further. If not, blocks 811-812 represent the Server stopping the progress and block 990 represents the Server ending the procedure. If so, block 300 represents the Server transmitting the requested service to the user's mobile terminal in order for the user to have the pick of multiple-choices or yes-no or self-tailored question items, and entering the unstructured data including personal notes and diaries, clinical results and relevant information, by using algorithms and latent variables. The menu screen displayed in the receiving mobile terminal is illustrated in FIGS. 13a-13d.

Blocks 400-401 are decision blocks determining whether the user is allowed to proceed for the selection of the service. If not, blocks 810 and 401 represent the Server stopping the progress and block 990 represents the Server ending the procedure. If the user requests to continue to accumulate more points, prizes, coupons and gifts, block 401 represents the Server moving back to the previous stage requesting more question items.

Block 500 represents the Server transmitting a list of health-related information/data matching with the accumulated health-related information/data, when the user requests to view the total accumulated health-related information/data or the list of trading records. Blocks 600-601 are decision blocks determining whether the user is allowed to have an access to the accumulated health-related information/data and trading records in the user's member account. If not, block 810 represents the Server stopping the progress and block 990 represents the Server ending the procedure. If the user requests to continue to select other kinds of services within the accumulated health-related information/data and trading records, block 601 represents the Server moving back to the previous stage requesting a different list of the service.

After required services are finally selected, block 700 represents the Server confirming the amendment/adjustment for the final health-related information/data, trading records and the user's member account. Blocks 800, 171 and 172 are decision blocks determining whether the user is entitled for the amendment/adjustment including membership, question items or responds, algorithms or latent variables and claims, etc.

Block 900 represents the Server verifying the final order for the service, when the final order for the service is transmitted to the Server via the mobile terminal. The user receives the request of verification explaining the scoring or trading details simultaneously in the receiving mobile terminal, wherein the final health-related information/data or the final order for the service is transmitted to the Server via the mobile terminal. The required services are set by the smart health management services program executed by the Server.

Block 990 represents the end of the smart health management services program.

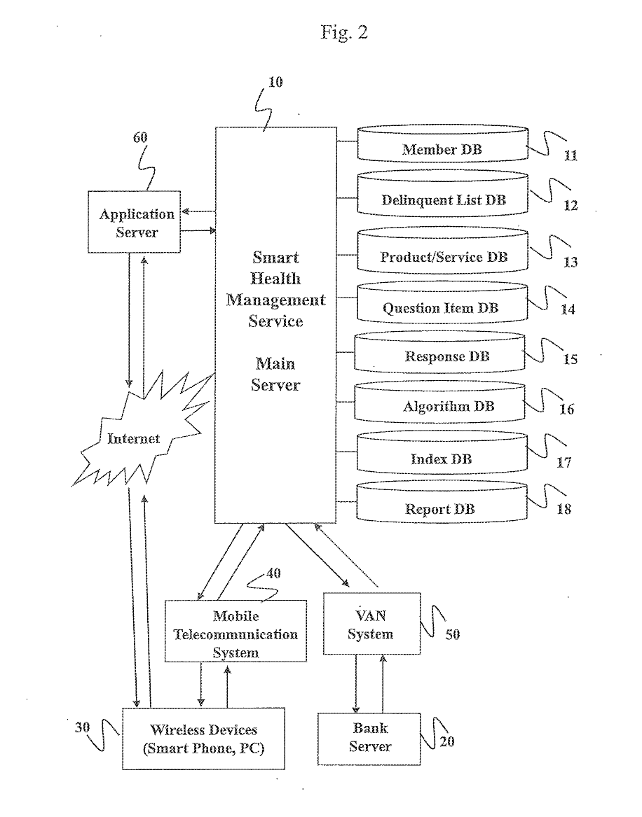

FIG. 2 is a diagram showing a general configuration of operating system of the present invention.

Referring to FIG. 2, in addition to a mobile telecommunication system 40, an internet is connected to Application Server 60 and Smart Health Management Service Main Server 10.

Main Server 10 provides preliminarily stored mobile contents to the mobile terminal 30 by way of a mobile communication network and Application Server 60. The mobile terminal 30 receives mobile contents from Main Server 10 which transmits mobile contents from DB 11-18 and modules 21-28 to enable the user to have a final report and trading records.

Member DB 11 stores individual information including Member ID, password and the member account. Member DB 13 stores the information of products and services provided by the members. Programmed contents of question items and respond are stored in Question Item DB 14 and Response DB 15 respectively.

Algorithm DB 16 stores the algorithm and latent variable which are models for items (categorical responses) measuring a common latent trait assumed to be continuous (or less often discrete) and typically representing an ability or a psychological attitude, and which define, map and measure formulations for health, disability and complete physical, mental, social well-being; describe the functioning level of daily wellness and health position in a more time efficient way; and provide an optimal functioning tool to resolve health-related problems independently by selecting the expert who can be accompanied with the optimum level of purpose in a person's wellness and health (development, participation and environment).

Index DB 17 stores a collection of health-related data entries, and supports efficient retrieval of all data entries with a given key value. Indexing is used to speed up access to desired data at any given time. Indexes are data structures that allow to find record IDs of records with given values in index search key fields. A choice of alternatives for data entry in Index is orthogonal to the indexing techniques including hash-based structures and tree-based structures (B+ trees and R trees). Data entries have several indexes on a given file of data records, each with a different search key. Index contains auxiliary information that directs searches to the desired data entries.

Report DB 18 stores the reports which provide smart phone users with tailored support service system including solutions to health-related problems, either on a regular or irregular basis, maintenance and control, healthy life management, financial management, and self-management. The smart health management service program causes automatically the Server to perform the method and system that comprises transmitting the personal data related to wellness and health with ease management and quality control, and to calculate and measure individual scores of wellness and health for individuals arranging from 0 to 100. (comparing the quality level of an individual wellness and health as a barometer in smart phones—Smart Index)

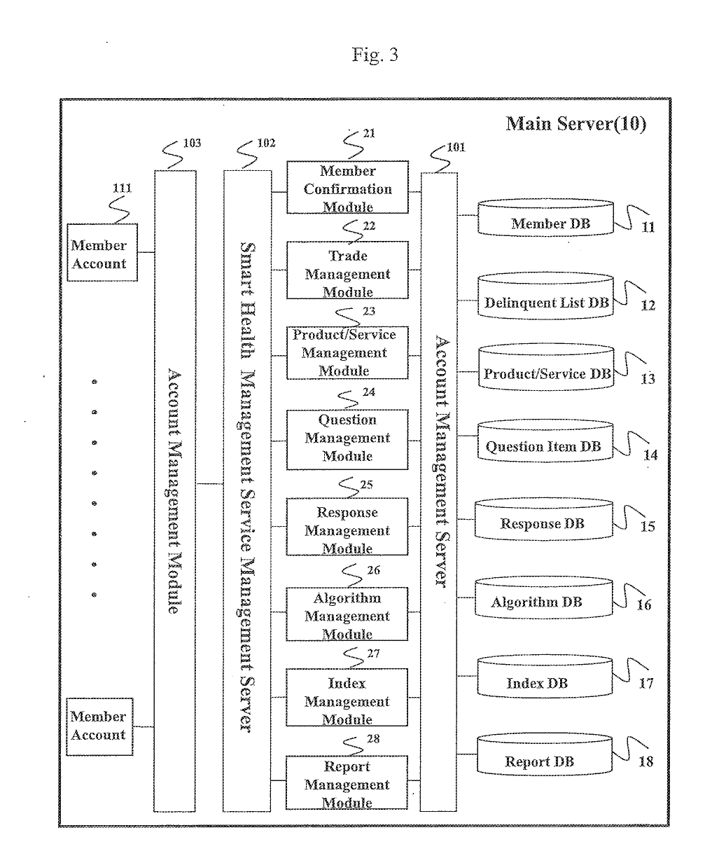

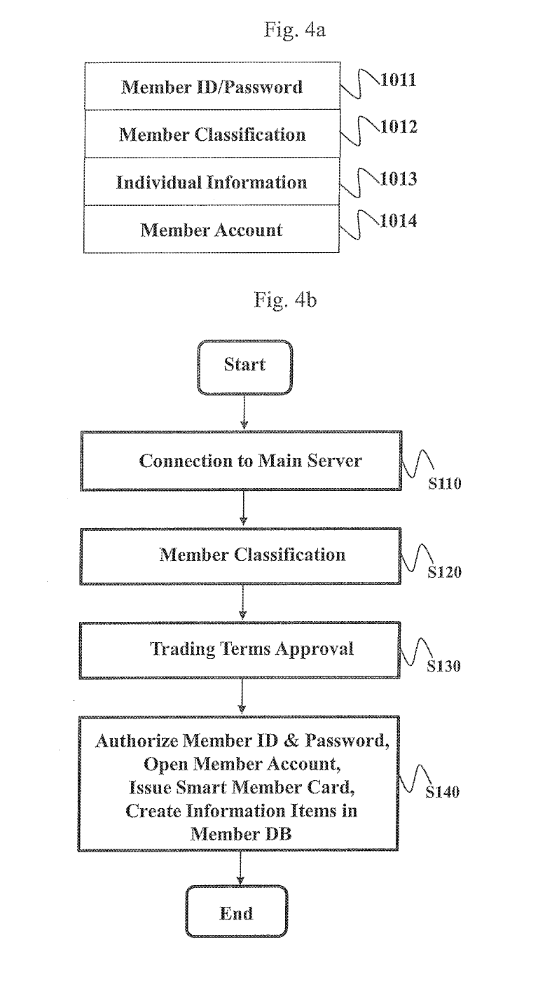

FIG. 3 is a diagram showing integral components of the Main Server in a second embodiment of the present invention.

Referring to FIG. 3, Main Server 10 accepts requested services from the user's mobile terminal, and manages the user's member account by providing for the personal results containing requested information, based on the program. If some error is found in orders or requests or while trying to server it, Main Server 10 has to send an error response explaining the health-related problems to the user's mobile terminal. Main Server 10 has also the capacity to log files, which allows Main Server 10 to log detailed information/data and serve responses, in order to collect information/data/statistics by running log analyzers on such contents.

Modules 21-28 are independent and interchangeable units which organize MPU in any preferred order as reusable formats, allow to add new information/data and to edit existing information/data with easy, and optimize for search. These modules are comprised of information/data control modules which allow even the non-technical user to create and schedule electronic presentations on the screen of the mobile terminal, and information/data delivery modules which contain elements and attributes that provide for run-time information/data choices and optimized information/data delivery. The user selects one of several alternative elements. The test attribute evaluates to either true/yes or false/no, the containing element is then played or ignored. The unstructured data including personal notes and diaries, clinical results and relevant information are also entered and evaluated by using algorithms and latent variables.

FIG. 4a is a diagram showing integral components of membership data processing of the present invention.

Referring to FIG. 4a, membership data include Member ID and password 1011; membership classification 1012, for example either individual consumers as general members or sponsors as special members; individual information 1013 including name, email address, mobile number, gender, date of birth, education, job, blood type, family history, special physical feature, BPSS information, and so on; and the member account 1014 with unique code through the use of the program executed by the Server.

FIG. 4b is a flowchart showing flow of process of joining a membership of the present invention.

Referring to FIG. 4b, block 110 represents the user who connects the Main Server and waits to apply for the member classification, member account and smart member card via the mobile terminal. Once the application for the member classification, member account and smart member card is accepted, control is transferred to blocks 120-140 to identify the request and respond accordingly. Block 120 represents the user proceeding to classify the individual information regarding an applicant. Once the user ends recording the member classification, control is transferred to blocks 130-140 to identify the request and respond accordingly. Block 130 represents the user proceeding to select relevant trading terms. Once the user ends selecting trading terms, control is transferred to block 140 to identify the request and respond accordingly. Block 140 represents the user proceeding to become a member, to have Member ID, password 1011, member account and smart member card, and to create information items in Member DB.

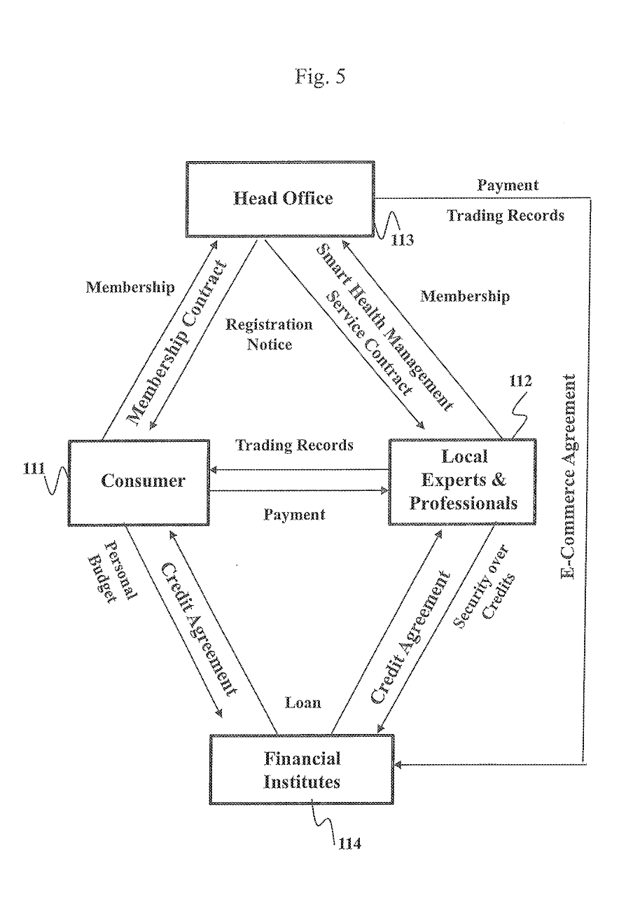

FIG. 5 is a diagram showing the parties to the present invention.

Referring to FIG. 5, Consumer 111 and Local Experts and Professionals 112 can apply for the membership of the smart health management service program. Head Office 113 accepts requested services from the user of the mobile terminal and supports responses to the user of the mobile terminal by providing for the personal results containing requested information/data. Head Office 113 collects information/data/statistics from members in order to provide Financial Institutes 114 with a tool of personal budget system suitable for the user's financial needs.

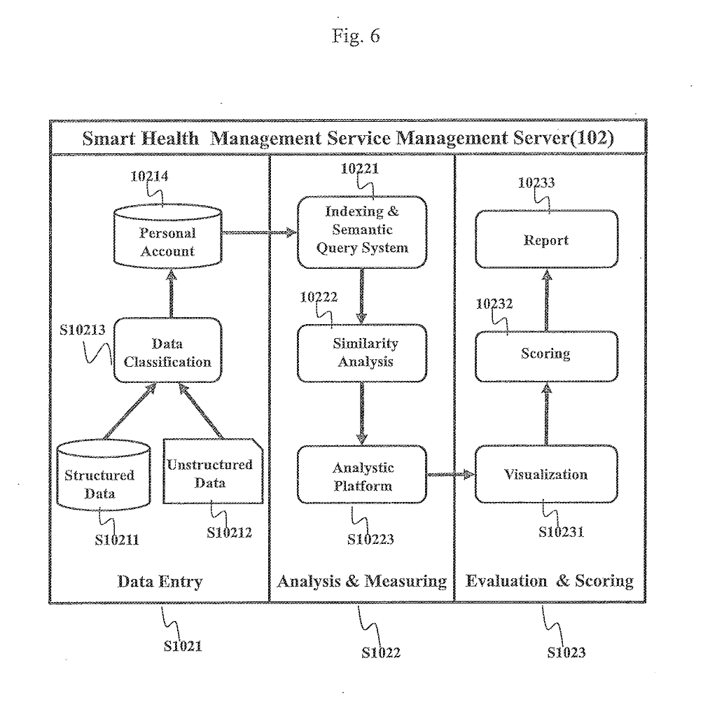

FIG. 6 is a flowchart showing flow of scalable computation engine and progress of analyzing health management service platform in a first embodiment of the present invention;

Referring to FIG. 6, Smart Health Management Service Management Server 102 consists of several blocks, connected by the data flow interface. Each block refers to a specific component, that induces the information/data transformation process. The main components of Smart Health Management Service Management Server are (1) data entry (S1021); (2) analysis and measuring (S1022); and (3) evaluation and scoring (S1023). All components contain one or more sub-components, which provide different approaches to the same task. The data entry component refers to an input of structured and unstructured data (S10211), data classification (S10212) and collection in the personal account (S10213). The next stage of analysis and measuring component focuses on analytical algorithms of analyzing and measuring the data entity. The main steps of analyzing and measuring algorithms are indexing and semantic query system (S10221), similarity analysis (S10222) and analytic platform (S10223).

The final evaluation and scoring component is visualization and scoring for a tailored report. The system gathers all the information/data related to each individual user, from a number of sources. This supporting information/data for each individual user is sent to a scoring stage. This scoring stage acts on the personal results containing requested information, evaluating a number of dimensions of information/data, and produce a combined score for each individual user. Finally, the reporting stage uses programs representing to rank the different individuals, to map data structures and data types onto parallel infrastructure in the most effective way and to come up with the scores and recommendations with the best confidence. These evaluation and scoring processes include visualization (S10231), scoring (S10232), and report (S10233).

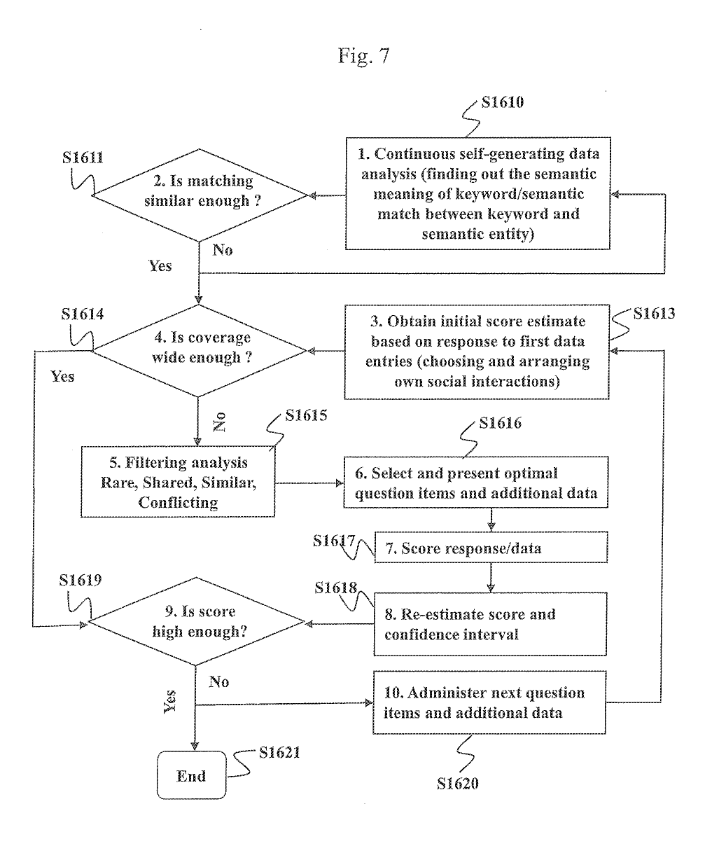

FIG. 7 is a flowchart showing flow of analytic program structure of health management service platform in a third embodiment of the present invention;

Referring to FIG. 7, block 1610 represents the user who connects the site and inputs continuous self-generating data via the mobile terminal. In order to find out the semantic meaning of keyword/semantic match between keyword and semantic entity, control is transferred to blocks 1610-1619 to identify the request and respond accordingly.

Blocks 1611, 1614 and 1619 are decision blocks determining whether the user is allowed to process further. If not, block 1620 represents the Server ending the procedure.

If the user requests to continue to select the service in different categories, block 1611 represents the Server moving back to the previous stage requesting different services.

Block 1613 represents the user proceeding to obtain initial score estimate based on response to first data entries by choosing and arranging own social interactions.

Block 1614 is a decision block determining whether the user is allowed to proceed with inputting additional information/data for coverage. If coverage is not wide enough, block 1615 represents the Server filtering analysis with data classification of Rare, Shared, Similar, Conflicting to select and present optimal question items and additional data for the next procedure.

Block 1616 represents the user continuing to select and input optimal question items and additional data, wherein such question items and additional information/data are processed to obtain scores. Blocks 1617 and 1618 represent the Server producing scores for response and data entries and re-estimating scores with the best confidence.

Block 1619 is a decision block determining whether the user achieves sufficient high scores through the use of the program of health management service executed by the Server. If yes, Block 1621 represents the end of the smart health management services program. If not, block 1620 represents the Server continuing the progress to administer next question items and additional data and moving back to the previous stage (S1613).

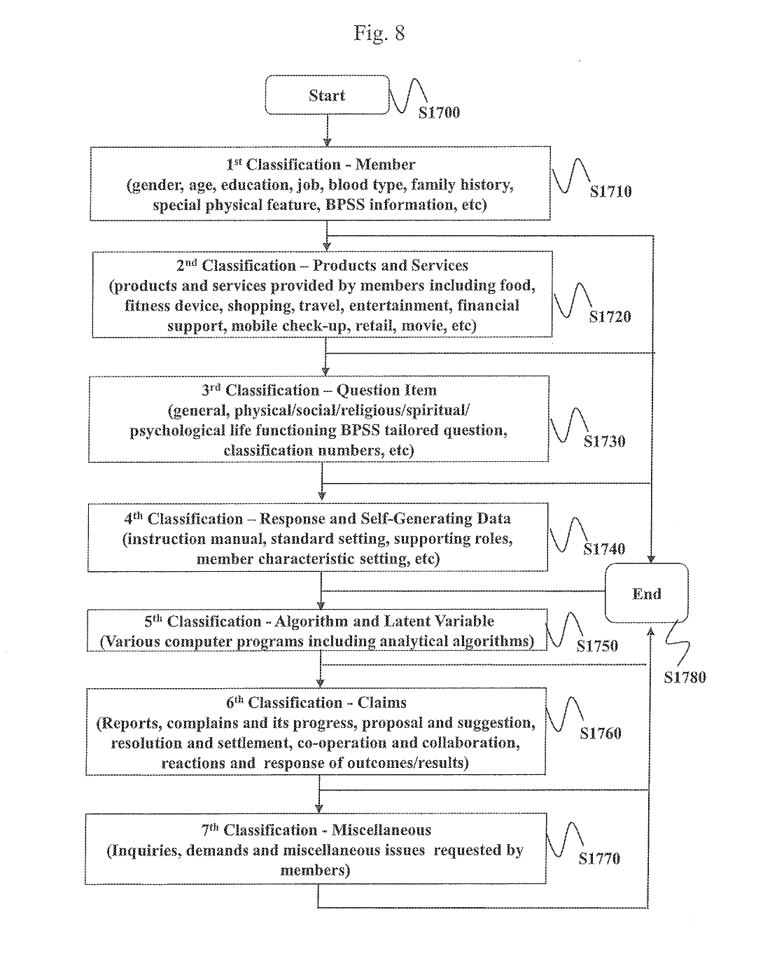

FIG. 8 is a flowchart showing flow of progress of receiving a final report by the classification system in a sixth embodiment of the present invention.

Referring to FIG. 8, a flowchart shows the classification of reports including information of membership, question item, response, algorithm and latent variable, claims and miscellaneous. Block 1710 represents the user proceeding to record the information regarding an individual member. Once the user ends recording the information, control is transferred to blocks 1720-1770 to identify the request and response accordingly. Block 1720 represents products and services provided by members. Once the user ends recording the information, control is transferred to blocks 1730-1770 to identify the request and response accordingly. Block 1730 represents the user proceeding to select relevant question items. Once the user selects question items, control is transferred to blocks 1740-1770 to identify the request and respond accordingly. Block 1740 represents the user proceeding to have the pick of relevant question items and to input continuous self-generating data regarding an individual member. Once the user completes the response of question items, control is transferred to blocks 1750-1760 to identify the request and respond accordingly.

Block 1750 represents the user proceeding to select the application of relevant algorithms and/or latent variables. Once the user selects such an application, control is transferred to blocks 1760-1770 to identify the request and respond accordingly. Block 1760 and Block 1770 represent the user proceeding to record claims and/or miscellaneous issues respectively. Once the user ends recording such an information, control is transferred to blocks 1770-1780 to identify the request and respond accordingly. Whenever the user stops selecting any relevant requests at any stage, the process ends.

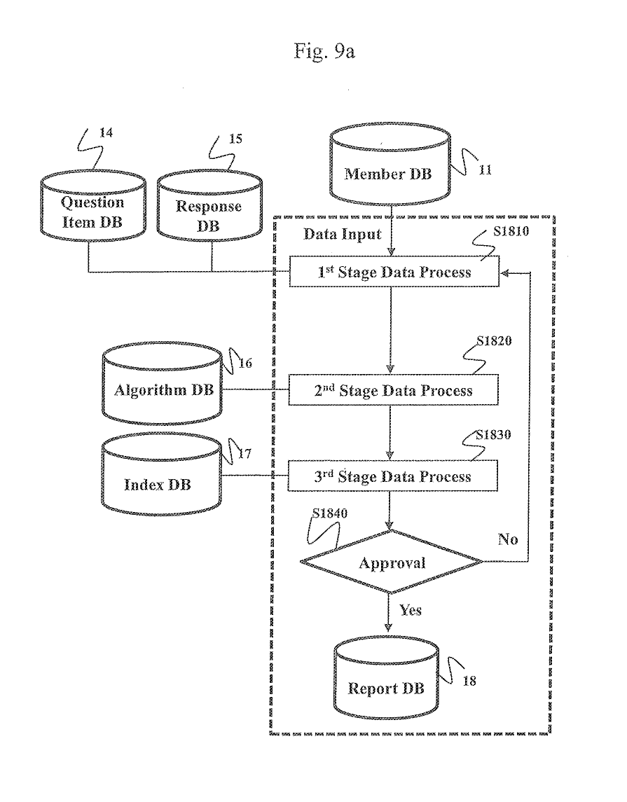

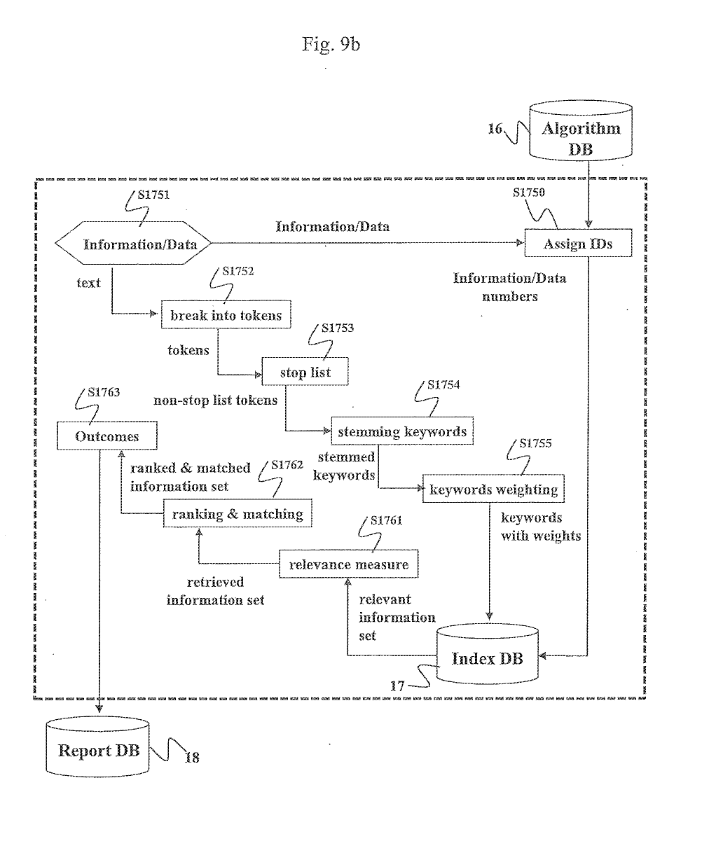

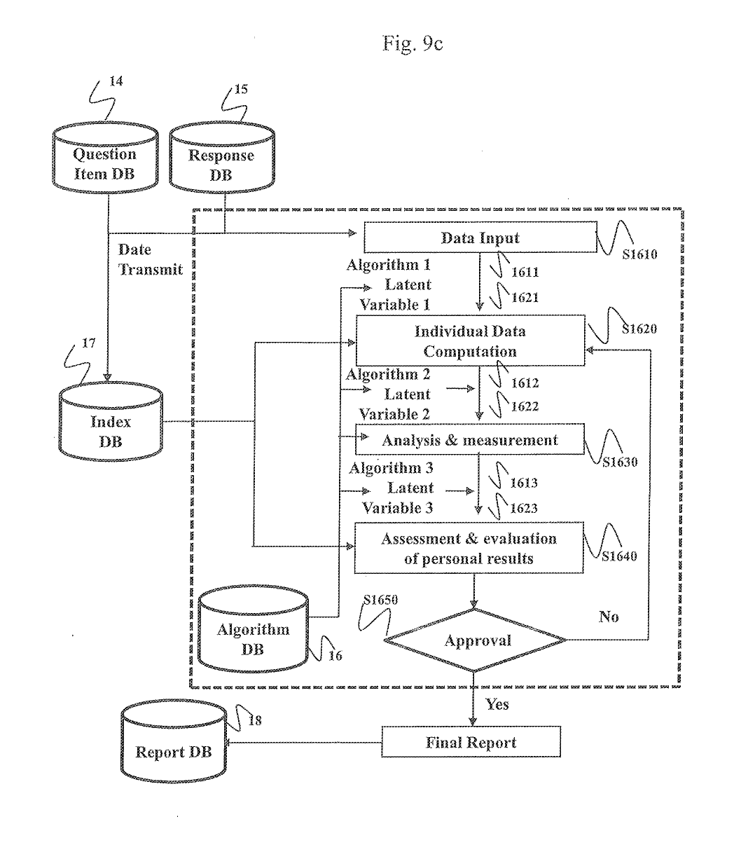

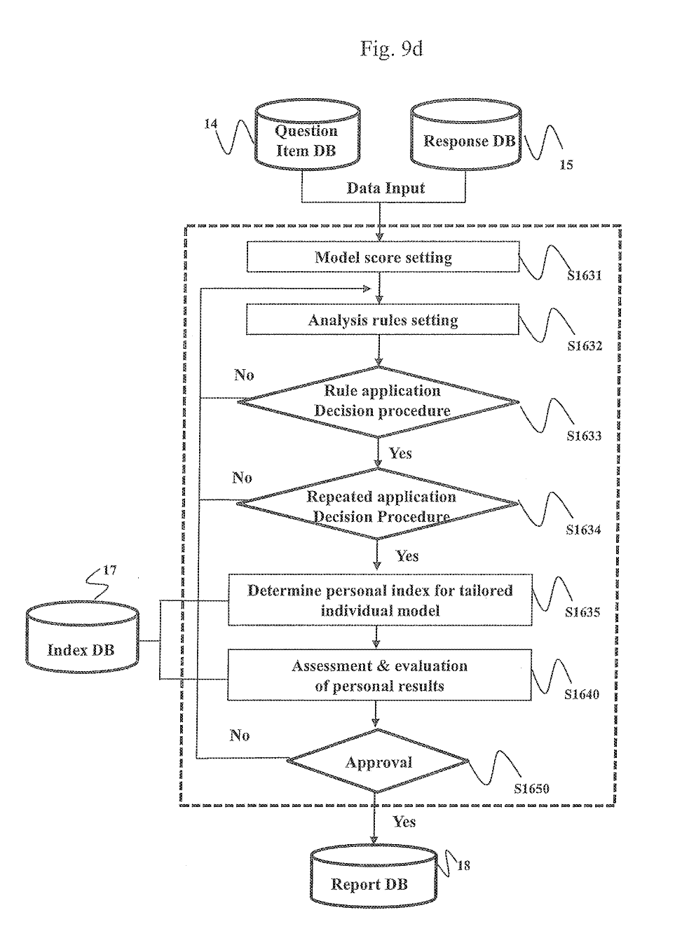

FIG. 9a, FIG. 9b, FIG. 9c and FIG. 9d are flowcharts showing flow of progress of storing the member's health-related information/data in Report DB (18) by using question items and response, algorithms and latent variables, the ICD as an international common standard language through Question Item DB (14), Response DB (15), Algorithm DB (16) and Index DB (17).

Referring to FIG. 9a, block 1810 represents the 1^{st} stage of data process which the user proceeds to input question items and response via the mobile terminal. Once data input ended, control is transferred to blocks 1820-1840 to identify the request and respond accordingly.

Block 1820 represents the 2^{nd} stage of data process which the user proceeds to compute individual date by using algorithms and latent variables. Once individual data computation ended, control is transferred to blocks 1830-1840 to identify the request and respond accordingly.

Block 1830 represents the 3^{rd} stage of data process which the user proceeds to determine the quality level of an individual life as a personal index for tailored individual model (Smart Index), based on an international common standard language of ICD. Once personal index measurement ended, control is transferred to block 1840 to identify the request and respond accordingly.

Block 1840 is a decision block approving the personal results of individual data and transmitting and storing such results in Report DB. If not, control is transferred to blocks 1810-1840 to identify the request and respond accordingly.

Referring to FIG. 9b, block 1751 represents the user proceeding to input information/data (question items and response, continuous self-generating data) via the mobile terminal. Once data input ended, control is transferred to block 1750 to identify such information/data by using algorithms and latent variables.

Blocks 1751-1756 represent the input stage of data process which the user proceeds to compute individual date by using algorithms and latent variables. Once individual data computation ended, control is transferred to blocks 1761-1763 to identify the request and respond accordingly.

Block 1761 represents the output stage of data process which the user proceeds to determine the relevance level of a relevant information/data set as a personal index for tailored individual model (Smart Index), based on an international common standard language of ICD. Once personal index measurement ended, control is transferred to block 1762 to rank and match the retrieved information/data set accordingly.

Block 1763 represents the personal results of ranked and matched information/data set and transmitting and storing such results in Report DB.

Referring to FIG. 9c, block 1610 represents the user proceeding to input data (question items and response, continuous self-generating data) via the mobile terminal. Once data input ended, control is transferred to blocks 1620-1650 to identify the request and respond accordingly.

Block 1620 represents the user proceeding to compute individual date by using algorithms and latent variables (1611, 1621). Once individual data computation ended, control is transferred to blocks 1630-1650 to identify the request and respond accordingly.

Block 1630 represents the user proceeding to measure scores of individual data by using algorithms and latent variables (1612, 1622). Once score measurement ended, control is transferred to blocks 1640-1650 to identify the request and respond accordingly.

Block 1640 represents the user proceeding to analyze and assess the personal results of individual data by using algorithms and latent variables (1613, 1623). Once score measurement ended, control is transferred to block 1650 to identify the request and respond accordingly.

Block 1650 is a decision block approving the personal results of individual data and transmitting and storing such results in Report DB. If not, control is transferred to blocks 1620-1650 to identify the request and respond accordingly.

Referring to FIG. 9d, block 1631 represents the user proceeding to set a model score of data input (response to question items) by using algorithms and latent variables. Once a model score setting ended, control is transferred to blocks 1632-1650 to identify the request and respond accordingly.

Block 1632 represents the user proceeding to set analysis rules for individual date by using algorithms and latent variables. Once analysis rules setting ended, control is transferred to blocks 1633-1650 to identify the request and respond accordingly.

Blocks 1633 and 1634 are decision blocks applying rules for individual data by using algorithms and latent variables. If not, the Server stopping the progress and moving back to the previous stage.

Block 1635 represents the user proceeding to determine personal index for tailored individual model by using algorithms and latent variables. Once personal index measurement ended, control is transferred to blocks 1640-1650 to identify the request and respond accordingly.

Block 1640 represents the user proceeding to analysis and assess personal results of tailored individual model by using algorithms and latent variables. Once personal results analysis and assessment ended, control is transferred to block 1650 to identify the request and respond accordingly.

Block 1650 is a decision block approving the personal results of individual data and transmitting and storing such results in Report DB. If not, control is transferred to blocks 1632-1650 to identify the request and respond accordingly.

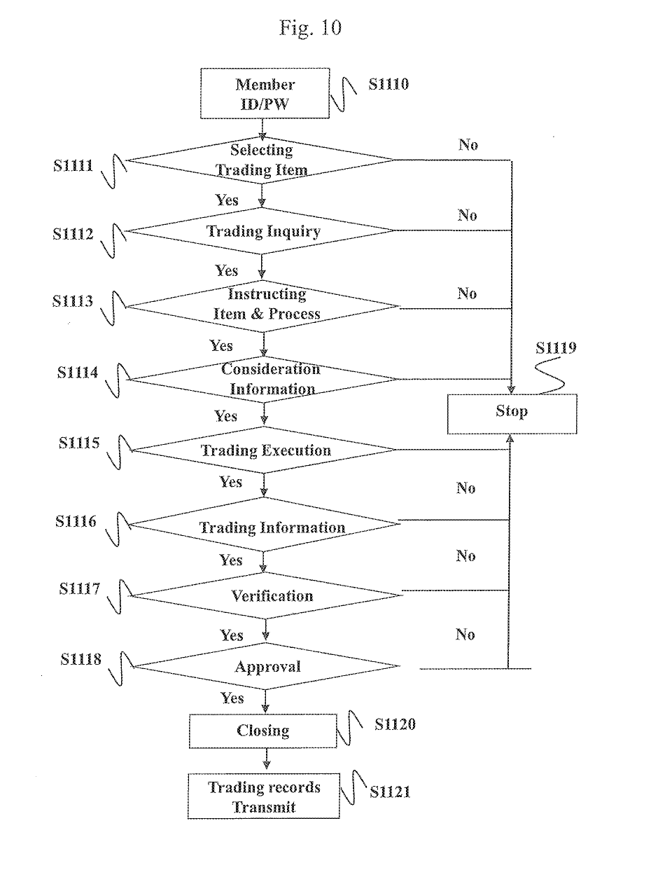

FIG. 10 is a flowchart showing flow of progress of selecting trading items, executing trading transactions, verifying members, approving transactions and transmitting trading records in a first embodiment of the present invention. Referring to FIG. 10, the information of trading records is stored in Member DB 11 according to the membership classification.

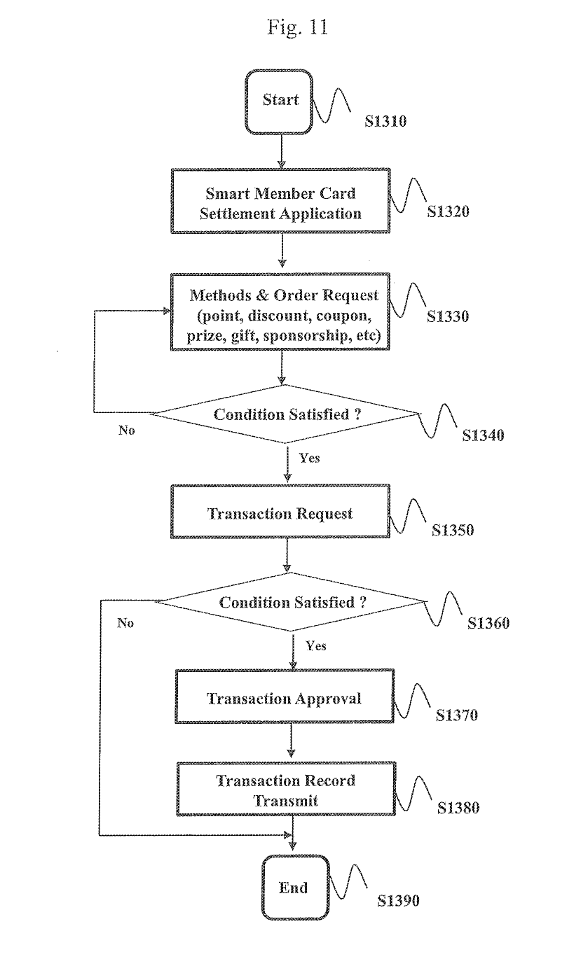

FIG. 11 is a flowchart showing flow of process of settlement transactions in a sixth embodiment of the present invention.

Referring to FIG. 11, block 1310 represents the user who connects the site and waits to confirm Member ID and password via the mobile terminal. Once Member ID and password is confirmed, control is transferred to blocks 1320-1390 to identify the request and respond accordingly. Block 1320 represents the user proceeding to apply for a settlement via the mobile terminal or a smart member card. Once the settlement application is accepted, control is transferred to blocks 1330-1370 to identify the request and respond accordingly. Block 1330 represents the user proceeding with the settlement by using points, discount, coupons, prize, gift, sponsorship, and so on, in the user's member account, based on methods and order request of the program. Once the user ends the settlement process, control is transferred to blocks 1340-1370 to identify the request and respond accordingly.

Block 1340 is a decision block determining whether the user is allowed to proceed for the settlement. If not, the Server moving back to the previous stage (1330).

Block 1350 represents the user proceeding to continue the requested transaction. Once the user ends the transaction, control is transferred to blocks 1360-1390 to identify the request and respond accordingly.

Block 1360 is a decision block determining whether the user is allowed to proceed for the transaction. If not, the process ends (1390).

Block 1370 represents the user proceeding to consent for the transaction. Once the user ends consenting the transaction, control is transferred to blocks 1380-1390 to identify the request and respond accordingly. Block 1380 represents the user proceeding to remit the transaction record and the process ends (1390).

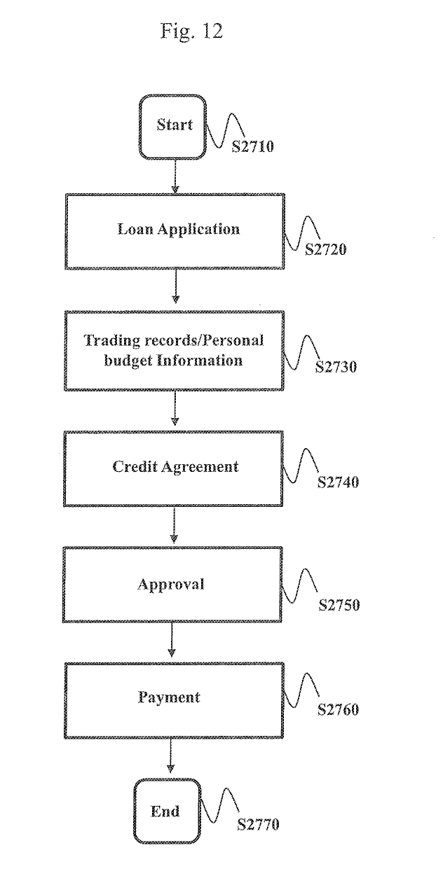

FIG. 12 is a flowchart showing flow of process of applying a loan application in a sixth embodiment of the present invention.

Referring to FIG. 12, block 2710 represents the user who connects the site and waits to confirm Member ID and password via the mobile terminal and/or a smart member card. Once Member ID and password is confirmed, control is transferred to blocks 2720-2770 to identify the request and respond accordingly. Block 2720 represents the user proceeding to apply for a loan application via the mobile terminal and/or a smart member card. Once the loan application is accepted, control is transferred to blocks 2730-2770 to identify the request and respond accordingly. Block 2730 represents the user proceeding to provide for the individual information including trading records and personal budget information regarding the loan application. Once the user ends providing for the individual information, control is transferred to blocks 2740-2770 to identify the request and respond accordingly. Block 2740 represents the user proceeding to select relevant trading terms of a Credit Agreement. Once the user ends selecting trading terms, control is transferred to blocks 2750-2770 to identify the request and respond accordingly. Block 2740 represents the user proceeding to consent for approved trading terms of the Credit Agreement. Once the user ends consenting trading terms, control is transferred to blocks 2760-2770 to identify the request and respond accordingly. Block 2760 represents the user proceeding to receive the payment and the process ends (2770).

FIG. 13a, FIG. 13b, FIG. 13c and FIG. 13d are diagrams showing an example of the menu screen displayed in the receiving mobile terminal in a ninth embodiment of the present invention.

Referring to FIG. 13a, block 130001 represents the Server transmitting product/service information to the user in the receiving mobile terminal. Blocks 11101-11801 represent information delivery modules which contain elements and attributes that provide the user with runtime information choices and optimized information delivery.

Referring to FIG. 13b, block 1342 represents the Server transmitting product information to the user in the receiving mobile terminal. Blocks 1342101 and 1342101201 represent information delivery modules which contain elements, and attribute that provide the user with runtime information choices and optimized information delivery.

Referring to FIG. 13c, block 1321 represents the Server transmitting service information to the user in the receiving mobile terminal. Blocks 1321050 and 1321050107 represent information delivery modules which contain elements, and attribute that provide the user with runtime information choices and optimized information delivery.

Referring to FIG. 13d, block 1383 represents the Server transmitting service information to the user in the receiving mobile terminal. Blocks 1383061 and 1383061903 represent information delivery modules which contain elements, and attribute that provide the user with runtime information choices and optimized information delivery.

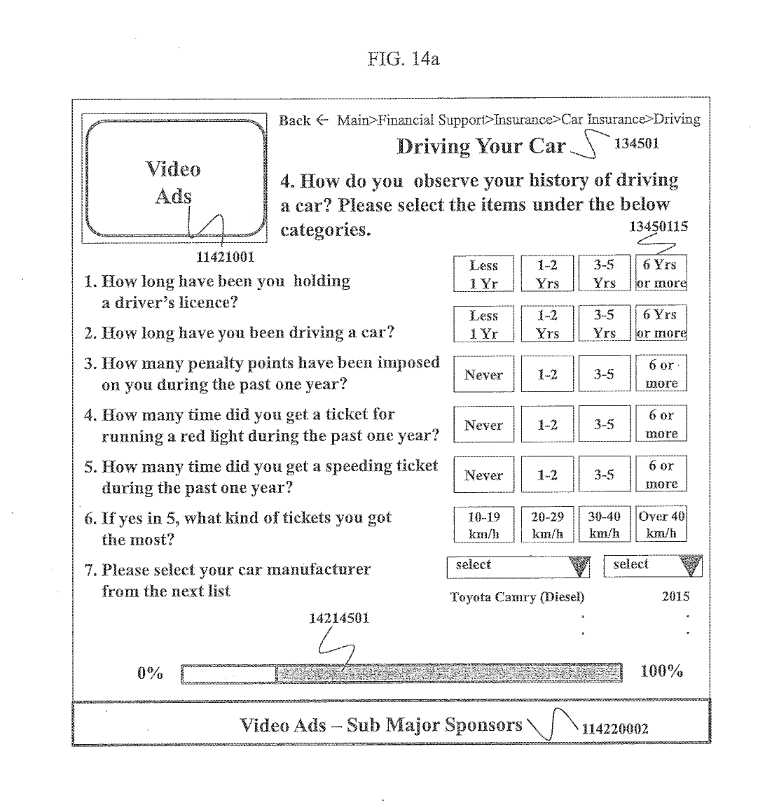

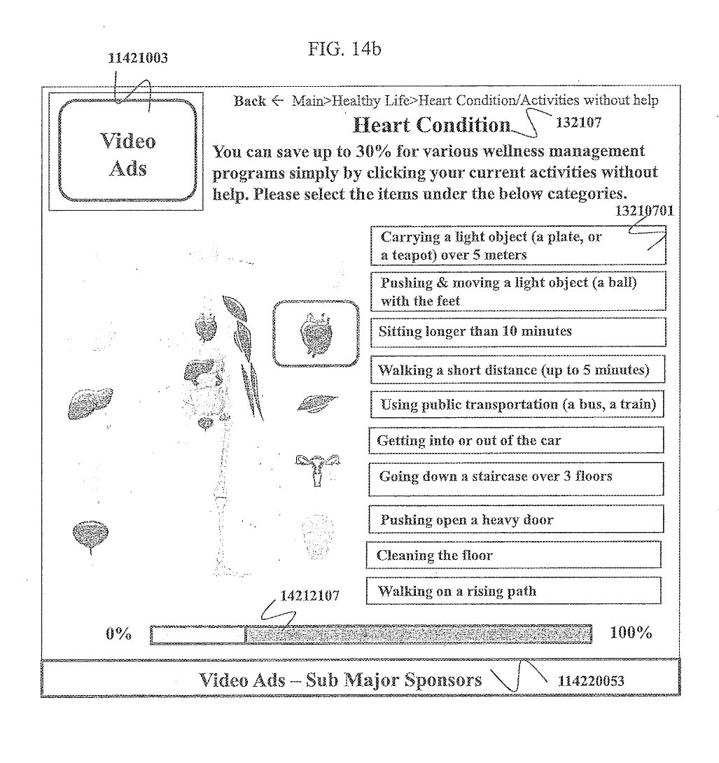

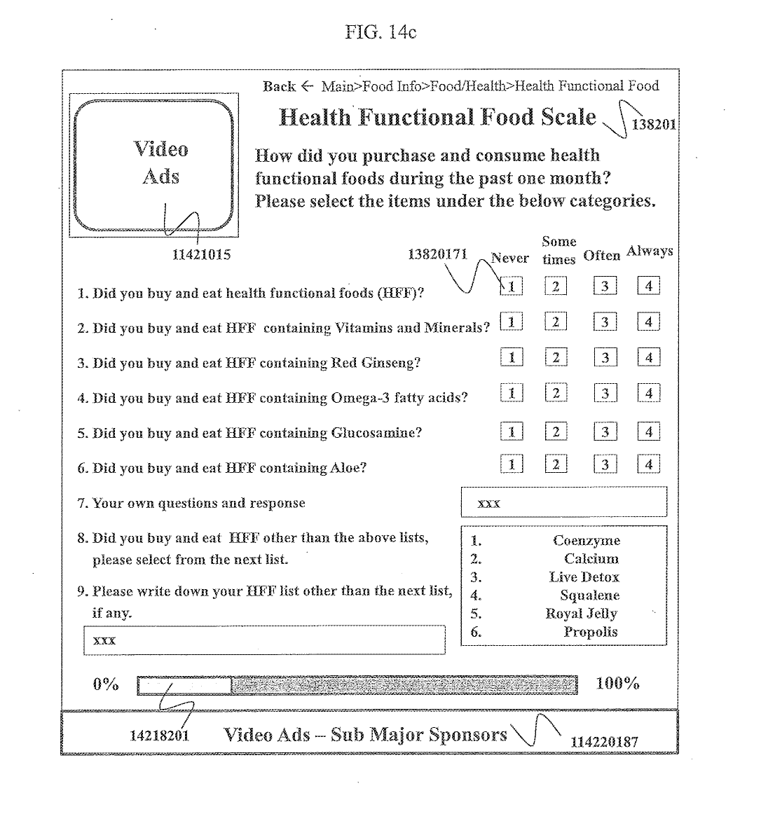

FIG. 14a, FIG. 14b and FIG. 14c are diagrams showing an example of question items and response displayed in the receiving mobile terminal in a ninth embodiment of the present invention.

Referring to FIG. 14a, block 134501 illustrates a multiple-choice question item with the time limit (14214501). Blocks 11421001 and 114220002 represent a video advertising of the sponsor through the use of the program executed by the Server. Block 13450115 represents how the user has the pick of the multiple-choice question item.

Referring to FIG. 14b, block 132107 illustrates a multiple-choice question item with the time limit (14212107). Blocks 11421003 and 114220053 represent a video advertising of the sponsor through the use of the program executed by the Server. Block 13210701 represents how the user has the pick of the multiple-choice question item.

Referring to FIG. 14c, block 138201 illustrates a multiple-choice question item with the time limit (14218201). Blocks 11421015 and 114220187 represent a video advertising of the sponsor through the use of the program executed by the Server. Block 13820171 represents how the user has the pick of the multiple-choice question item.

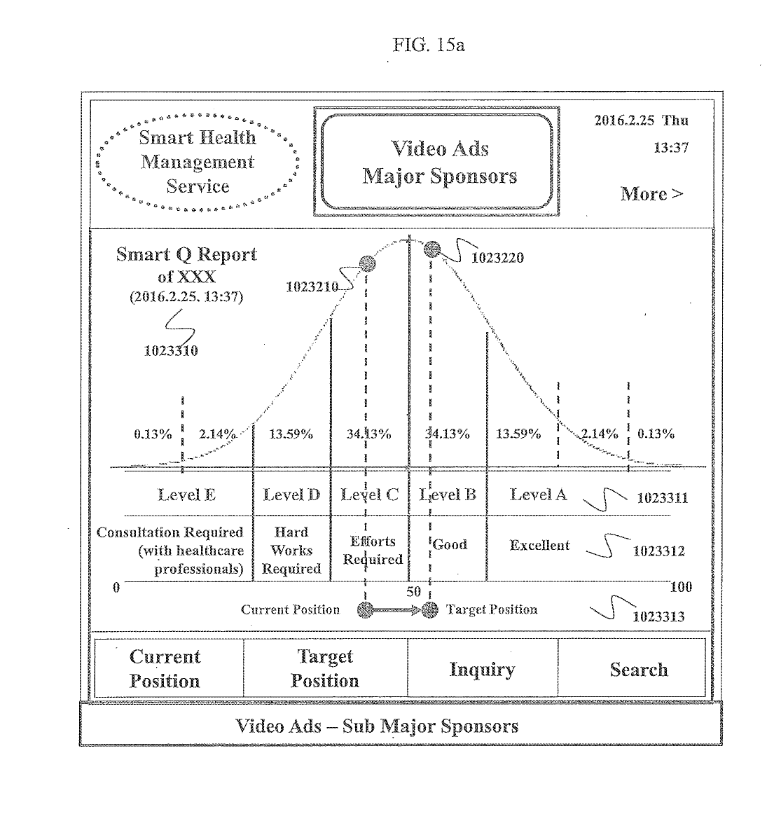

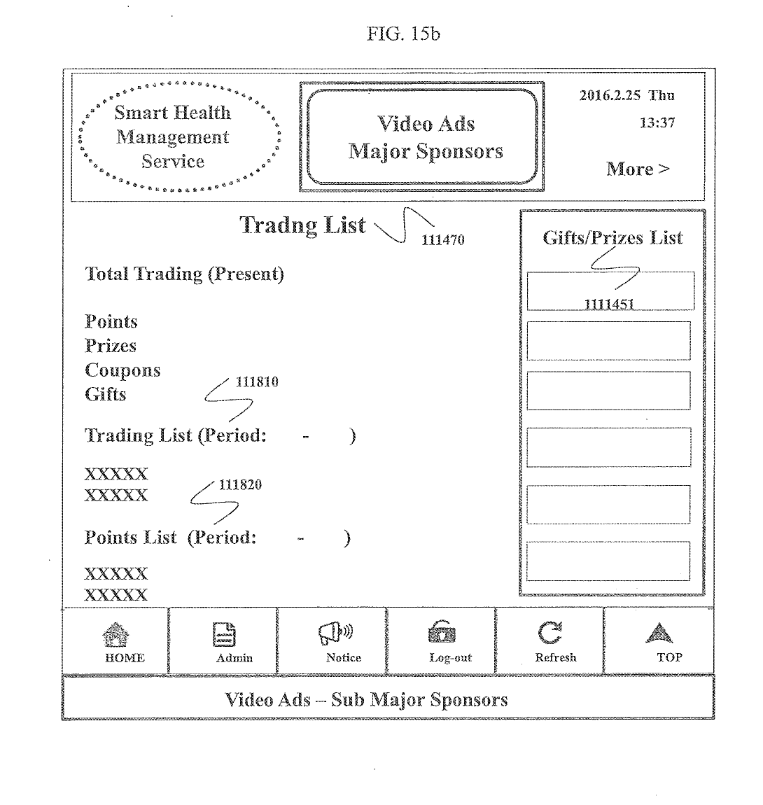

FIG. 15a and FIG. 15b are diagrams/graphs showing an example of Smart Q scores and the trading list displayed in the receiving mobile terminal in a ninth embodiment of the present invention.

Referring to FIG. 15a, block 1023310 illustrates how the user has a Smart Q Score report. Blocks 1023311 and 1023312 illustrate the classification of Smart Q Scores through the use of the smart health management service program executed by the Server. Blocks 1023210, 1023220 and 1023313 illustrate, how the current and the target positions of user's wellness and health are displayed, when the user views the report in the receiving mobile terminal.

Scales scores represent the user's current status along the continuum of smart health management represented by the items in the section being assessed. An increase in score means that the user's performance of level has increased. An alternative interpretation is to say that differences in scaled scores represent the absolute amount of change that has occurred from one assessment occasion to another. Smart Q Score is unique to assessments developed using smart health management service program.

Referring to FIG. 15b, block 111470 illustrates how the user has the trading records. Blocks 111810-111820 illustrate the verification with bar code through the use of the Smart health management service program executed by the Server. Block 111451 illustrates, how a list of gifts information matching with the points is displayed, when the user views the accumulated points.

The present invention has been described with reference to the accompanying drawings. The description given above is merely illustrative and is not meant to be exhaustive or to limit to all possible embodiments, applications or modifications of the present invention. This is just one of various embodiments including the subject matter of the invention and intends to allow those skilled in the art to easily embody the present invention. Various modifications and variations of the above-described methods and systems of the present invention will be apparent to those skilled in the art without departing from the broader scope of the invention presented herein. These and other modifications and variations upon the exemplary embodiments are intended to be covered by the present invention. Although the present invention has been described in connection specific embodiments, it should be understood that the present invention as claimed should not be unduly limited to such specific embodiments. The scope of the present invention should be construed by the following claims.

What is claimed is:

1. A method for smart health management service by using an automation platform installed in smart phones in order to provide smart phone users with a tailored and self-supporting service system, comprising:
(1) arranging required agreements with the mobile terminal user who opens a member account by providing individual information, registering Member ID and password and accepting the terms and conditions of articles offered (Member Agreement), with the local experts and professionals who provide health management services (Service Agreement), and with financial institutes which provide short term loans for the user (Credit Agreement);
(2) displaying the time limit of responding the question items, when the user selects the question item or generates own tailored question item;
(3) simultaneously verifying the response for the final pick or response of the question item, when the final pick or response is transmitted;
(4) storing information and trading records (Question Items and Response) by using algorithms and latent variables in order to present personal reports in a specified manner to the user via the mobile terminal based on the smart health management services program, when the service is selected;
(5) receiving requests for individual information including Member ID, question items and response, health-related information, trading records and the unstructured data including personal notes and diaries, clinical results and relevant information, and storing them in relevant DB according to the program;
(6) setting a model score of data input and analysis rules for individual data, applying rules for individual data by using algorithms and latent variables, determining personal index (Smart Index) for tailored individual model by using algorithms and latent variables, analyzing and assessing personal results of a tailored individual model by using algorithms and latent variables, and approving the personal results of individual data and transmitting and storing such results in Report DB;
(7) reproducing, delivering, streaming or downloading the personal results in the receiving mobile terminal;
(8) automatically storing relevant information and trading records in the user's account viewing them in DB in real time, while they are read or selected or reproduced;
(9) calculating and measuring individual scores of wellness and health arranging from 0 to 100 (comparing the quality level of an individual life as a barometer in smart phones—Smart Index);
(10) accumulating points, prizes, coupons and gifts in the user's member account as a result of responding the question item, based on the program;
(11) automatically responding the matching of the accumulated points and a list of gifts information in the receiving mobile terminal, when the user views the accumulated points;
(12) automatically transmitting the information of selected gifts, prizes and coupons to the user's mobile terminal;
(13) automatically settling the transactions for points, prizes, coupons and gifts in the user's member account based on the program; and
(14) automatically searching key words and meanings in accordance with systematically coded classification and inter-operable encoding system for diseases and health-related information (the ICD content model as an international common standard language and international coding structure).

2. The method of claim 1, wherein Requested Lists of Information (RLI) is transmitted by the mobile terminal to the Server via a secured telecommunication.

3. The method of claim 1, measuring the matching of RLI and Approved Lists of Information (ALI), and analyzing and assessing the personal results by using the smart health management services program executed by the Server.

4. The method of claim 3, if ALI is greater than or equals RLI, the program causes automatically the Server to perform the method that comprises reproducing, delivering, streaming or downloading the personal results in the receiving mobile terminal.

5. The method of claim 3, wherein the final response of the question items is transmitted to the Server via the mobile terminal, the program causes automatically the Server to perform the method that further comprises simultaneously transmitting the verification of the final response to the user's mobile terminal.

6. The method of claim 3, wherein the response of the question items is transmitted to the Server and becomes effective before the closing date expired, the program causes automatically the Server to perform the method that further the program causes automatically the Server to perform the method and system that further comprises transmitting the personal data related to life functions and activities with ease measurement and assessment, and quality control based on the program in the user's member accounts.

7. The method of claim 3, wherein the user's request for the personal results is transmitted to the Server via the mobile terminal, the program causes automatically the Server to perform the method that further comprises responding the individual scores measurement of wellness and health arranging from 0 to 100. (comparing the quality level of an individual life as a barometer in smart phones—Smart Index).

8. The method of claim 3, if ALI fails to be greater than or to equal RLI, the program causes automatically the Server to perform the method that further comprises moving backward to the previous stage for the user to repeat the process.

9. The method of claim 7, wherein the order for a loan application is transmitted to the Server via the mobile terminal, the program causes automatically the Server to perform the method of a tool of personal budget system that further comprises providing reasonable budgeting and sharing suitable for user's financial needs, based on the program.

10. The method of claim 9, wherein the Server receives the personal budget via the mobile terminal, the program causes automatically the Server to perform the method that further comprises simultaneously selecting a financial institute which is interested in providing a short-term loan based on the personal budget and transmitting an application form of the credit agreement to the user's mobile terminal.

11. The method of claim 10, wherein the Server receives the approval for the loan application via the mobile terminal, the program causes automatically the Server to perform the method that further comprises securing the payment into the applicant's account, based on the program.

12. The method of claim 7, wherein the order for a goal management is transmitted to the Server via the mobile terminal, the program causes automatically the Server to perform the method of a practical tool that further comprises providing an action-based model behavior and the golden schedule on the ground of activity-based personal life and regular activity model, and goal management by using coaching system to achieve a reasonable personal goal, based on the program.

13. The method of claim 12, wherein the Server receives the personal goal via the mobile terminal, the program causes automatically the Server to perform the method that further comprises simultaneously selecting an expert or professional who understands the problem and the level of problem solving sequence with the field of an applicant's life in the background, and is able to accompany with the optimum level of purpose in an applicant's wellness and health (development, participation and environment).
